(19) United States
(12) Patent Application Publication
(10) Pub. No.: US 2005/0198433 A1
(43) Pub. Date: Sep. 8, 2005

(54) Storage device controlling apparatus and method of controlling the same

(75) Inventors: Naotaka Kobayashi, Kanagawa (JP); Yutaka Takata, Kanagawa (JP); Shinichi Nakayama, Kanagawa (JP); Jinichi Shikawa, Chiba (JP); Nobuyuki Saika, Kanagawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/056,520

(22) Filed: Feb. 10, 2005

Related U.S. Application Data
(63) Continuation of application No. 10/754,371, filed on Jan. 9, 2004.

(30) Foreign Application Priority Data
Jan. 20, 2003 (JP) 2003-011592

(51) Int. Cl. G06F 12/00

(52) U.S. Cl. 711/112; 711/163

(57) ABSTRACT

A storage device controlling apparatus including a channel controller having a circuit board on which a file access processing section and an I/O processor are formed, the file access processing section receiving requests to input and output data in files as units from an information processing apparatus via a network, the I/O processor outputting I/O requests corresponding to the requests to input and output data to a storage device, the apparatus comprising: an exclusive control section performing exclusive control of a file when the channel controller receives from the information processing apparatus the requests to input and output data of the file.

### CROSS-REFERENCE TO RELATED APPLICATIONS

The present application claims priority upon Japanese Patent Application No. 2003-011592 filed on Jan. 20, 2003, which is herein incorporated by reference.

### BACKGROUND OF THE INVENTION

1. Field of the Invention

The present invention relates to a storage device controlling apparatus and a method of controlling the same.

2. Description of the Related Art

In recent years, the amount of data handled by computer systems has been greatly increased. As storage systems for managing these data, large-scale storage systems called a mid-range class or enterprise class, managed according to a RAID (Redundant Arrays of Inexpensive Disks) method which provides an enormous storage source, are drawing attention these days. Moreover, to efficiently manage the enormous amount of data, a technology has been developed, in which an exclusive network (Storage Area Network; hereinafter referred to as SAN) connects information processing apparatuses and a storage system such as a disk array apparatus to implement high-speed and massive access to the storage system.

Meanwhile, a storage system called a NAS (Network Attached Storage) has been developed, in which a network using TCP/IP (Transmission Control Protocol/Internet Protocol) protocols, etc., connects a storage system and information processing apparatuses to implement access in file level from the information processing apparatuses (e.g., Japanese Patent Application Laid-Open Publication No. 2002-351703).

However, a conventional NAS has been achieved by connecting information processing apparatuses having TCP/IP communication and file system functions to a storage system without TCP/IP communication and file system functions. Therefore, installation spaces have been required for the abovementioned information processing apparatuses to be connected. Moreover, the information processing apparatuses and storage system are usually connected by a SAN in order to perform high-speed communication. Thus, the information processing apparatus has been required to be provided with a communication controlling apparatus or a communication controlling function.

### SUMMARY OF THE INVENTION

The present invention has been made in view of the abovementioned problems, and the main object of the present invention is to provide a storage device controlling apparatus and a method of controlling the storage device controlling apparatus.

In order to solve the abovementioned problems, the storage device controlling apparatus according to the present invention is a storage device controlling apparatus including a channel controller having a circuit board on which a file access processing section and an I/O processor are formed, the file access processing section receiving requests to input and output data in files as units sent from an information processing apparatus via a network, the I/O processor outputting I/O requests corresponding to the requests to input and output data to a storage device, the apparatus comprising: an exclusive control section performing exclusive control of a file when the channel controller receives from the information processing apparatus the requests to input and output data of the file.

Note that the information processing apparatus is, for example, a personal computer or a mainframe computer which accesses a storage system comprising the storage device controlling apparatus having the abovementioned structure via LAN or SAN. The function of the file access processing section is provided by an operating system executed on CPU and software such as NFS (Network File System) which runs on this operating system. The storage device is a disk drive such as a hard disk unit. The I/O processor comprises, for example, an IC (Integrated Circuit) separate from the CPU as a hardware element, which is the hardware element of the file access processing section, and controls the communication between the file access processing section and the disk controller. The disk controller writes and reads data into and from the storage device.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a block diagram showing the entire construction of a storage system according to the present embodiment;

FIG. 2 is a block diagram showing the construction of a managing terminal according to the present embodiment;

FIG. 3 is a view showing a physical disk managing table according to the present embodiment;

FIG. 4 is a view showing an LU managing table according to the present embodiment;

FIG. 5 is a view showing the exterior structure of the storage system according to the present embodiment;

FIG. 6 is a view showing the exterior structure of a storage device controlling apparatus according to the present embodiment;

FIG. 7 is a view showing a CHN according to the present embodiment;

FIG. 8 is a view showing a CHF and CHA according to the present embodiment;

FIG. 9 is a view for explaining the contents of data stored in a memory according to the present embodiment;

FIG. 10 is a view showing a disk controller according to the present embodiment;

FIG. 11 is a view showing the structure of software according to the present embodiment;

FIG. 12 is a view showing the structure of a cluster in channel controllers according to the present embodiment;

FIG. 13 is a view showing metadata according to the present embodiment;

FIG. 14 is a view showing lock tables according to the present embodiment;

FIG. 15 is a flowchart for explaining exclusive control in files according to the present embodiment;

FIG. 16 is a flowchart for explaining exclusive control in LUs according to the present embodiment;

FIG. 17 is a flowchart for explaining fail-over control according to the present embodiment;

FIG. 18 is a view for explaining the contents of data stored in a shared LU to perform the fail-over control according to the present embodiment;

FIG. 19 is a block diagram for explaining control of fast access to files according to the present embodiment; and

FIG. 20 is a view for explaining the contents of data stored in an LU to perform the control of fast access to files according to the present embodiment.

### DETAILED DESCRIPTION OF THE INVENTION

At least the following matters will be made clear by the explanation in the present specification and the description of the accompanying drawings.

An embodiment of the present invention will be described in detail below with reference to the drawings.

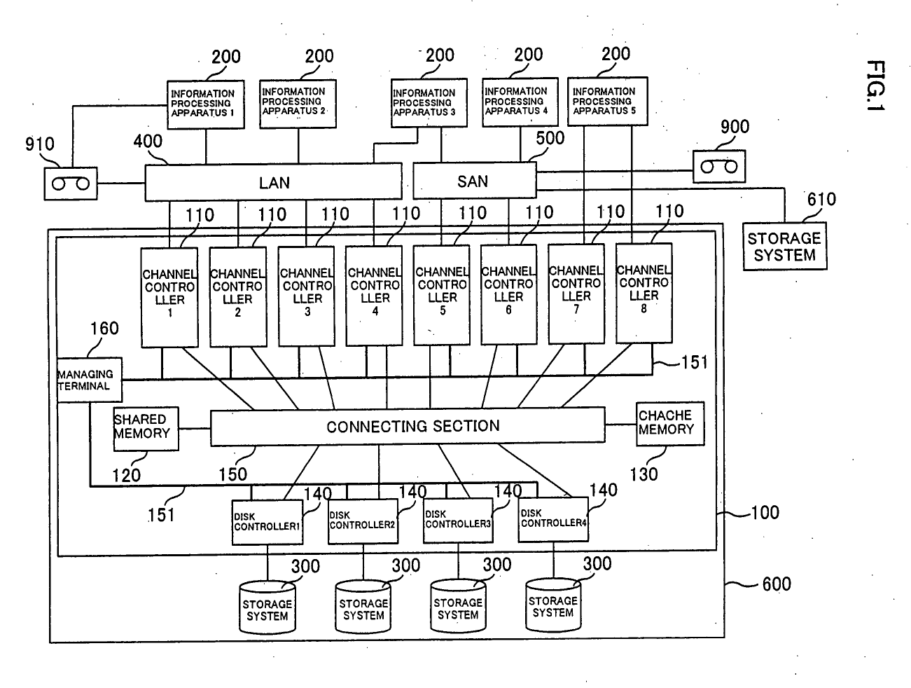

FIG. 1 is a block diagram showing the entire construction of a storage system 600 according to the present embodiment.

### EXAMPLE OF THE ENTIRE CONSTRUCTION

The storage system 600 comprises a storage device controlling apparatus 100 and storage devices 300. The storage device controlling apparatus 100 controls the storage devices 300 according to commands received from information processing apparatuses 200. For example, when requests to input and output data are received from an information processing apparatus 200, the storage device controlling apparatus 100 performs processing for the input and output of data stored in a storage device 300. Data is stored in a memory area, a logical volume (Logical Unit; hereinafter referred to as LU) logically set in a physical memory area provided by the disk drive of the storage device 300. The storage device controlling apparatus 100 also receives various commands from the information processing apparatuses 200 to manage the storage system 600.

The information processing apparatus 200 is a computer having a CPU (Central Processing Unit) and a memory. Execution of various programs by the CPU provided in the information processing apparatus 200 implements various functions. The information processing apparatus 200 is, for example, a personal computer, a workstation or a mainframe computer.

In FIG. 1, the information processing apparatuses 1 to 3 (200) are connected to the storage device controlling apparatus 100 via a LAN (Local Area Network) 400. The LAN 400 may be the Internet or an exclusive network. Communication between the information processing apparatuses 1 to 3 (200) and the storage device controlling apparatus 100 is performed via the LAN 400 according to, for example, TCP/IP protocols. The information processing apparatuses 1 to 3 (200) send the storage system 600 data access requests with specified file names (requests to input and output data in terms of files; hereinafter referred to as file access requests).

The LAN 400 is connected to a backup device 910, which is specifically a disk-based device such as MO, CD-R or DVD-RAM, or a tape-based device such as a DAT tape, cassette tape, open tape or cartridge tape. The backup device 910 communicates with the storage device controlling apparatus 100 via the LAN 400 to store backup data for data stored in the storage device 300. Further, the backup device 910 can also be connected to the information processing apparatus 1 (200). In this case, backup data for data stored in the storage device 300 is acquired via the information processing apparatus 1 (200).

The storage device controlling apparatus 100 comprises channel controllers 1 to 4 (110). By the channel controllers 1 to 4 (110), the storage device controlling apparatus 100 communicates with the information processing apparatuses 1 to 3 (200) and the backup device 910 via the LAN 400. The channel controllers 1 to 4 (110) individually accept file access requests from the information processing apparatuses 1 to 3 (200). That is, the channel controllers 1 to 4 (110) are assigned respective network addresses on the LAN 400 (e.g., IP addresses), and each behaves as a NAS so that each channel controller can provide service as NAS to the information processing apparatuses 1 to 3 (200) as if separate NASs were present. Hereinafter, the channel controllers 1 to 4 (110) are each referred to as CHN. Thus, one storage system 600 is constructed to have the channel controllers 1 to 4 (110), which individually provide service as the NAS, and thereby NAS servers, which are operated individually on separate computers in the conventional art, are integrated into one storage system 600. Therefore, the entire storage system 600 can be managed so that various settings and controls, and maintenance such as fault management and version management are made more efficient.

Note that the channel controllers 1 to 4 (110) of the storage device controlling apparatus 100 according to the present embodiment are implemented by hardware formed on an integrally unitized circuit board and software such as an operating system (hereinafter, referred to as OS) executed by this hardware and application programs running on this OS, as described later. Thus, the functions of the storage system 600 according to the present embodiment, which are implemented as part of hardware in the conventional art, are implemented by software. Hence, the storage system 600 according to the present embodiment enables flexible system operation and can provide more finely tuned services to meet diverse and greatly varying user needs.

The information processing apparatuses 3, 4 (200) are connected to the storage device controlling apparatus 100 via a SAN (Storage Area Network) 500. The SAN 500 is a network for the storage device controlling apparatus 100 to exchange data with the information processing apparatuses 3, 4 (200) in blocks, units for managing data in the memory area provided by the storage device 300. The communication between the information processing apparatuses 3, 4 (200) and the storage device controlling apparatus 100 via the SAN 500 is performed usually according to a Fibre-Channel protocol. The information processing apparatuses 3, 4 (200) send requests to access data (hereinafter, referred to as block access requests) to the storage system 600 in blocks according to the Fibre-Channel protocol.

The SAN 500 is connected to a backup device 900 compatible with SAN, which communicates with the storage device controlling apparatus 100 via the SAN 500 to store backup data for data stored in the storage device 300.

The storage device controlling apparatus 100 comprises channel controllers 5, 6 (110). By the channel controllers 5, 6 (110), the storage device controlling apparatus 100 communicates with the information processing apparatuses 3, 4 (200) and the backup device 900 compatible with SAN via the SAN 500. Hereinafter, the channel controllers 5, 6 (110) are referred to as CHFs.

The information processing apparatus 5 (200) is connected to the storage device controlling apparatus 100 directly without a network such as the LAN 400 and the SAN 500. The information processing apparatus 5 (200) may be, for example, a mainframe computer. The communication between the information processing apparatus 5 (200) and the storage device controlling apparatus 100 is performed according to a communication protocol such as FICON (Fibre Connection) (registered trademark), ESCON (Enterprise System Connection) (registered trademark), ACONARC (Advanced Connection Architecture) (registered trademark), or FIBARC (Fibre Connection Architecture) (registered trademark). The information processing apparatus 5 (200) sends the storage system 600 block access requests according to the communication protocol.

The storage device controlling apparatus 100 communicates with the information processing apparatus 5 (200) by the channel controllers 7, 8 (110). Hereinafter, the channel controllers 7, 8 (110) are referred to as CHAs.

The SAN 500 is connected to another storage system 610 installed at a place (secondary site) remote from the place (primary site) where the storage system 600 is installed. The storage system 610 is used as a unit into which data is duplicated by a function of replication or remote copy. It is noted that the storage system 610 may also be connected to the storage system 600 via a communication line such as ATM, instead of the SAN 500. In this case, a channel controller 110 provided with an interface (channel extender) for using the abovementioned communication line is adopted.

According to the present embodiment, by installing CHNs 110, CHFs 110, and CHAs 110 together in the storage system 600, a storage system connected to different types of networks can be implemented. Specifically, the storage system 600 is a SAN-NAS integrated storage system, which is connected to the LAN 400 via CHNs 110 and to the SAN 500 via CHFs 110.

===Storage Device===

The storage device 300 comprises multiple disk drives (physical disks) and provides a memory area to the information processing apparatus 200. Data is stored in an LU, a memory area logically set on a physical memory area provided by the disk drive. Various units such as a hard disk unit, a flexible disk unit and a semiconductor memory unit can be used as the disk drive. Note that the storage device 300 can be, for example, a disk array formed of a plurality of disk drives. In this case, the memory area may be provided to the information processing apparatus 200 by the plurality of disk drives managed by a RAID.

The storage device controlling apparatus 100 and the storage devices 300 may be connected directly as shown in FIG. 1 or via a network. Alternatively, the storage devices 300 may be integrated with the storage device controlling apparatus 100.

LUs set in the storage device 300 include user LUs accessible from the information processing apparatuses 200, a system LU used for controlling a channel controller 110, and the like. Stored in the system LU is an operating system executed in a CHN 110. Each LU is made correspond to a channel controller 110, and thereby each channel controller 110 is assigned accessible LUs. In the correspondence, a plurality of channel controllers 110 can share one LU. Hereinafter, the user LU and the system LU are also referred to as a user disk and a system disk, respectively. An LU shared by a plurality of channel controllers 110 is referred to as a shared LU or a shared disk.

===Storage Device Controlling Apparatus===

The storage device controlling apparatus 100 comprises the channel controllers 110, a shared memory 120, a cache memory 130, disk controllers 140, a managing terminal 160, and a connecting section 150.

The channel controller 110 comprises a communication interface to communicate with the information processing apparatuses 200 and a function to receive data input and output commands, etc., from the information processing apparatuses 200. For example, the CHNs 110 accept file access requests from the information processing apparatuses 1 to 3 (200). Accordingly, the storage system 600 can provide service as a NAS to the information processing apparatuses 1 to 3 (200). The CHFs 110 accept block access requests from the information processing apparatuses 3, 4 (200) according to the Fibre-Channel protocol. Thus, the storage system 600 can provide high-speed accessible data storage service to the information processing apparatuses 3, 4 (200). The CHAs 110 accept block access requests from the information processing apparatus 5 (200) according to a protocol such as FICON, ESCON, ACONARC, or FIBARC. Accordingly, the storage system 600 can provide data storage service to the information processing apparatus 5, a mainframe computer.

The channel controllers 110 and the managing terminal 160 are connected by an internal LAN 151. Accordingly, micro-programs, etc., executed by the channel controllers 110 can be sent from the managing terminal 160 and installed therein. The construction of the channel controllers 110 is described later.

The connecting section 150 connects the channel controllers 110, the shared memory 120, the cache memory 130, and the disk controllers 140. Data and commands are sent and received to and from the channel controllers 110, the shared memory 120, the cache memory 130, and the disk controllers 140 via the connecting section 150. The connecting section 150 is constituted by, for example, a high-speed bus such as a superfast cross bus switch which transmits data by high-speed switching. Since the channel controllers 110 are connected each other by the high-speed bus, the communication performance between the channel controllers 110 is greatly improved over the conventional construction where the NAS servers operating on individual computers are connected via a LAN. This enables a high-speed file sharing function, high-speed fail-over, and the like.

The shared memory 120 and the cache memory 130 are memories shared by the channel controllers 110 and the disk controllers 140. The shared memory 120 is mainly used to store control information, commands, etc., while the cache memory 130 is mainly used to store data.

For example, when a data input and output command received by a channel controller 110 from an information processing apparatus 200 is a write command, the channel controller 110 writes the write command into the shared memory 120 and data received from the information processing apparatus 200 into the cache memory 130. Meanwhile, the disk controllers 140 are monitoring the shared memory 120. When the disk controllers 140 detect that the write command has been written into the shared memory 120, one of the disk controllers 140 reads the data from the cache memory 130 and writes the data into a relevant storage device 300 according to the command.

When a data input and output command received by a channel controller 110 from an information processing apparatus 200 is a read command, the channel controller 110 writes the read command into the shared memory 120 and checks whether to-be-read data is present in the cache memory 130. If the data is present in the cache memory 130, the channel controller 110 sends the data to the information processing apparatus 200. On the other hand, if the to-be-read data is not present in the cache memory 130, a disk controller 140 monitoring the shared memory 120 detects that the read command has been written into the shared memory 120 and reads the to-be-read data from a relevant storage device 300 to write the data into the cache memory 130 and a notice thereof in the shared memory 120. Thereafter, when the channel controller 110 detects that the to-be-read data has been written into the cache memory 130 by monitoring the shared memory 120, the channel controller 110 sends the data to the information processing apparatus 200.

Note that other than the construction where instructions to write and read data are indirectly sent from the channel controller 110 to the disk controller 140 via the shared memory 120, for example, the storage device controlling apparatus 100 may have construction where instructions to write and read data are sent directly from a channel controller 110 to a disk controller 140 without the shared memory 120.

A disk controller 140 controls a storage device 300. For example, as described above, according to a data write command received from an information processing apparatus 200, a channel controller 110 writes the data into the storage device 300. Further, a request sent from the channel controller 110 to access data in an LU designated by a logical address is converted into a request to access data in a physical disk designated by a physical address. If the physical disks in the storage device 300 are managed by RAID, data is accessed according to the structure of the RAID. Moreover, the disk controller 140 controls management of the duplication and backup of data stored in the storage device 300. Furthermore, the disk controller 140 controls to store duplication of data in the storage system 600 at the primary site into another storage system 610 installed in the secondary site (a replication or remote copy function) for the purpose of preventing data loss in the occurrence of disaster (disaster recovery).

The disk controllers 140 and the managing terminal 160 are connected each other via the internal LAN 151 and can communicate with each other. This enables micro-programs, etc., executed by the disk controllers 140 to be sent from the managing terminal 160 and installed therein. The construction of the disk controllers 140 is described later.

In the present embodiment, the shared memory 120 and the cache memory 130 are provided separately from the channel controllers 110 and the disk controllers 140. The present embodiment is not limited to this case. It is also preferable that the shared memory 120 or the cache memory 130 be dispersed to be provided in each of the channel controllers 110 and the disk controllers 140. In this case, the connecting section 150 connects the channel controllers 110 and the disk controllers 140, which have dispersed shared memories or cache memories.

===Managing Terminal===

The managing terminal 160 is a computer for maintaining and managing the storage system 600. By operating the managing terminal 160, it is possible to set the structure of the physical disks and LUs in the storage device 300 and install micro-programs executed by the channel controllers 110. Herein, in the setting of the structure of the physical disks in the storage device 300, for example, physical disks can be added or removed, and the RAID structure can be changed (e.g., a change from RAID1 to RAID5). Further, via the managing terminal 160, it is possible to perform various operations, including: confirming the operation state of the storage system 600; identifying a fault section; and installing operating systems executed by the channel controllers 110. Yet further, the managing terminal 160 is connected to an external maintenance center via a LAN, a telephone line, etc., so that it is possible to monitor faults in the storage system 600 and quickly deals with faults when occurred by use of the managing terminal 160. The occurrence of faults is notified by, for example, OSs, application programs, driver software, etc. The faults are notified through a HTTP protocol, a SNMP (Simple Network Management Protocol), e-mails and the like. These are set and controlled by an operator and the like via a Web page serving as a user interface provided by a Web server operating on the managing terminal 160. The operator and the like can also designate objects subjected to fault monitoring and set its contents and targets to be notified of faults.

The managing terminal 160 can be incorporated into the storage device controlling apparatus 100 or attached thereto externally. Further, the managing terminal 160 may be a computer which exclusively maintains and manages the storage device controlling apparatus 100 and the storage devices 300 or a general-purpose computer having a maintenance and management function.

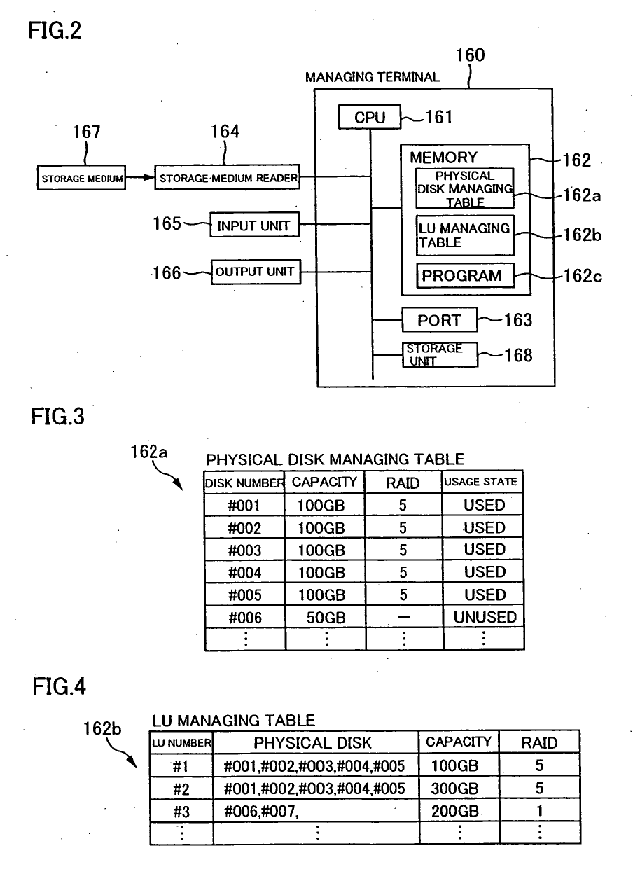

FIG. 2 is a block diagram showing the construction of the managing terminal 160.

The managing terminal 160 comprises a CPU 161, a memory 162, a port 163, a storage medium reader 164, an input unit 165, an output unit 166, and a storage unit 168.

The CPU 161 controls the whole managing terminal 160 and implements functions and the like as the abovementioned Web server, etc., by executing a program 162c stored in the memory 162. The memory 162 stores a physical disk managing table 162a, an LU managing table 162b, and the program 162c.

The physical disk managing table 162a is a table for managing the physical disks (disk drives) provided in a storage device/storage devices 300, and is shown in FIG. 3. In FIG. 3, of the multiple physical disks provided in the storage device/storage devices 300, disk numbers #001 to #006 are shown. The capacity, RAID structure, and usage state of each physical disk are shown.

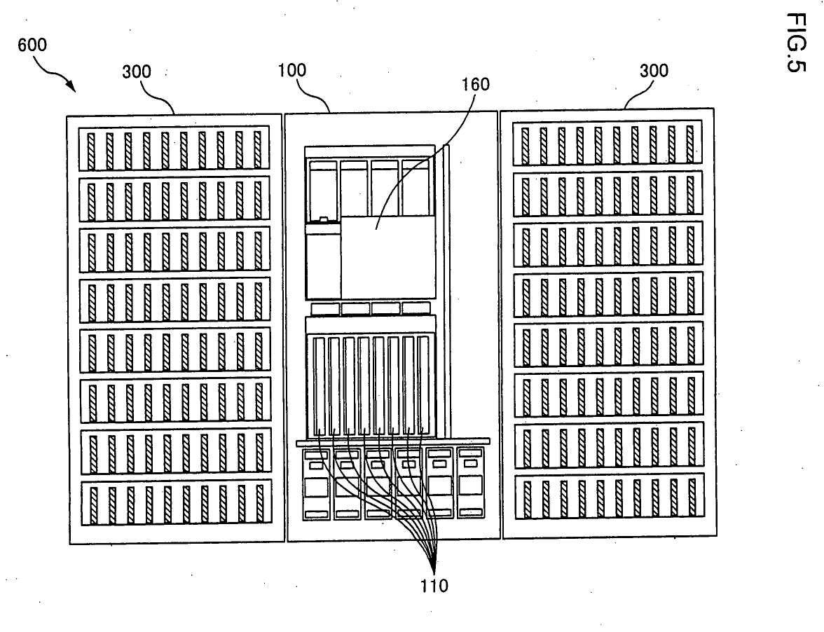

The LU managing table 162b is a table for managing the LUs set logically on the abovementioned physical disks, and is shown in FIG. 4. In FIG. 4, of the multiple LUs set in the storage device 300, LU numbers #1 to #3 are shown. The physical disk number, capacity, and RAID structure of each LU are shown.

The storage medium reader 164 is a unit for reading programs and data stored in a storage medium 167. Read programs and data are stored in the memory 162 or the storage unit 168. Accordingly, for example, the program 162c recorded in the storage medium 167 can be read by used of the storage medium reader 164 and stored in the memory 162 or the storage unit 168. A flexible disk, a CD-ROM, a semiconductor memory, etc., can be used as the storage medium 167. The storage medium reader 164 can be incorporated into the managing terminal 160 or attached thereto externally. The storage unit 168 is, for example, a hard disk unit, flexible disk unit, and a semiconductor memory unit. The input unit 165 is used by an operator, etc., to enter data, etc., into the managing terminal 160. Used as the input unit 165 is, for example, a keyboard, or a mouse. The output unit 166 is a unit for outputting information to the outside. Used as the output unit 166 is, for example, a display, or a printer. The port 163 is connected to the internal LAN 151, and thereby the managing terminal 160 can communicate with the channel controllers 110, the disk controllers 140 and the like. Further, the port 163 can be connected to the LAN 400 or a telephone line.

===Exterior Figure===

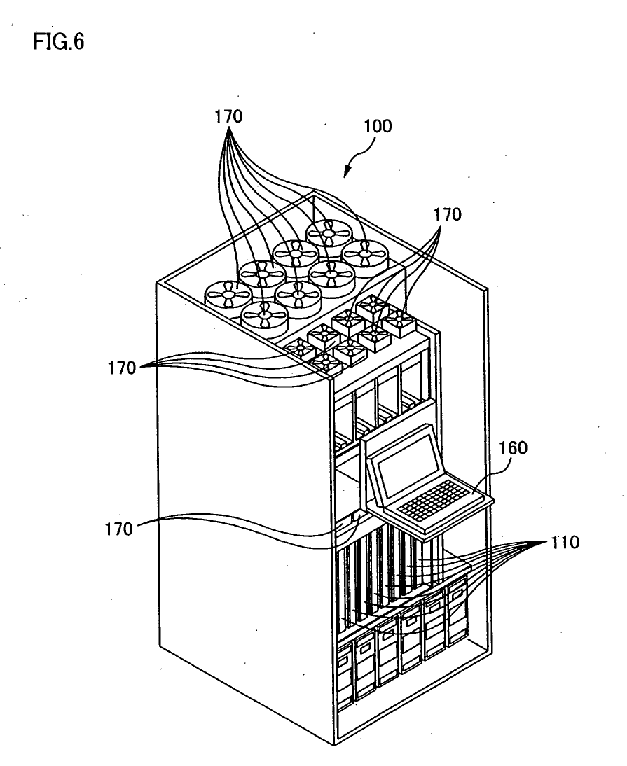

Next, FIG. 5 shows the exterior structure of the storage system 600 according to the present embodiment, and FIG. 6 shows the exterior structure of the storage device controlling apparatus 100.

As shown in FIG. 5, the storage system 600 according to the present embodiment has the storage device controlling apparatus 100 and the storage devices 300 contained in respective chassis. The chassis for the storage devices 300 are placed on both sides of the chassis for the storage device controlling apparatus 100.

The storage device controlling apparatus 100 comprises the managing terminal 160 provided at the center front. The managing terminal 160 is covered by a cover, and the managing terminal 160 can be used by opening the cover as shown in FIG. 6. Note that while the managing terminal 160 shown in FIG. 6 is a so-called notebook personal computer, it may take any form.

Provided under the managing terminal 160 are slots to which the channel controllers 110 are to be attached. The board of a channel controller 110 is attached to each slot. The storage system 600 according to the present embodiment has eight slots. FIGS. 5 and 6 show a state where the eight slots have the channel controllers 110 attached thereto. Each slot is provided with guide rails to attach a channel controller 110. By inserting the channel controller 110 into the slot along the guide rails, the channel controller 110 is attached to the storage device controlling apparatus 100. By pulling the channel controller 110 toward the front along the guide rails, the channel controller 110 can be removed. Further, provided on the surface facing forwards in the back of each slot is a connector for connecting a channel controller 110 to the storage device controlling apparatus 100 electrically. The channel controllers 110 are CHNs, CHFs, and CHAs. Since each channel controller 110 is compatible with the others in size and in the position and pin arrangement of its connector and the like, the eight slots can have any channel controller 110 attached thereto. Therefore, for example, all the eight slots can have the CHNs 110 attached thereto. Alternatively, as shown in FIG. 1, the eight slots can have four CHNs 110, two CHFs 110, and two CHAs 110 attached thereto, or some of the slots may have no channel controller 110.

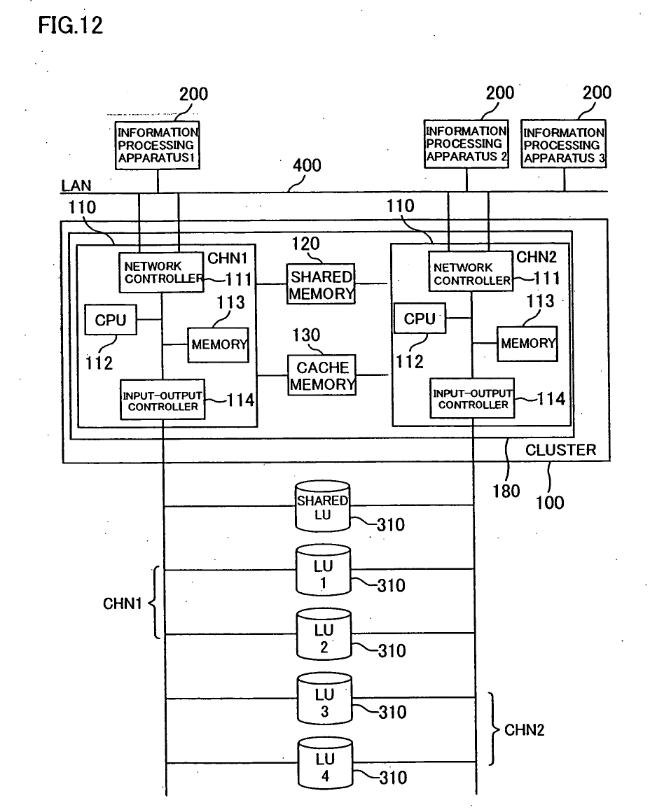

Of the channel controllers 110 attached to the slots, plural channel controllers 110 of the same type constitute a cluster. For example, two CHNs 110 as a pair may constitute a cluster. By constituting a cluster, even when a fault has occurred in a channel controller 110 of the cluster, another channel controller 110 in the cluster may be arranged to take over processing that the channel controller 110, where the fault has occurred, was performing until then (fail-over control). FIG. 12 shows two CHNs 110 constituting a cluster, which is described in detail later.

Note that the storage device controlling apparatus 100 has two systems of power supply to improve reliability, and the abovementioned eight slots, to which channel controllers 110 are attached, are divided into two groups of four for the respective power supply systems. Hence, when forming a cluster, the cluster is arranged to include channel controllers 110 respectively connected to both power supply systems. Thus, even if a failure occurs in one of the power supply systems to stop supplying electric power, electric power continues to be supplied to another channel controller 110 connected to the other power supply system forming part of the same cluster. Therefore, another channel controller 110 can take over the processing from the relevant channel controller 110 (fail-over).

Note that, as described above, while each channel controller 110 is provided as a board that can be attached to any of the slots, that is, as a unit formed on the same board, the unit may include a plurality of boards. In other words, even if a unit is formed of a plurality of boards, the concept of the same circuit board includes a group of boards that are connected each other and integrated as a unit and can be integrally attached to a slot of the storage device controlling apparatus 100.

Other units forming part of the storage device controlling apparatus 100, such as the disk controllers 140 and the shared memory 120, are not shown in FIGS. 5 and 6, but attached to the back, etc., of the storage device controlling apparatus 100.

The storage device controlling apparatus 100 is provided with fans 170 for releasing heat generated in the channel controllers 110, etc. The fans 170 are provided on the tops of the slots for the channel controllers 110 as well as on the top of the storage device controlling apparatus 100.

For example, units having conventional structures that are manufactured complying with a SAN can be used as the storage device controlling apparatus 100 and the storage devices 300 contained in respective chassis. In particular, by making the connector's shape of the CHN take such a shape that it can be directly attached to a slot provided in a conventionally structured chassis as described above, the units having conventional structures can be used more easily. The storage system 600 according to the present embodiment can be easily constructed by using the existing products.

===Channel Controller===

As described above, the storage system 600 according to the present embodiment accepts file access requests from the information processing apparatuses 1 to 3 (200) by CHNs 110, and provides service as a NAS to the information processing apparatuses 1 to 3 (200).

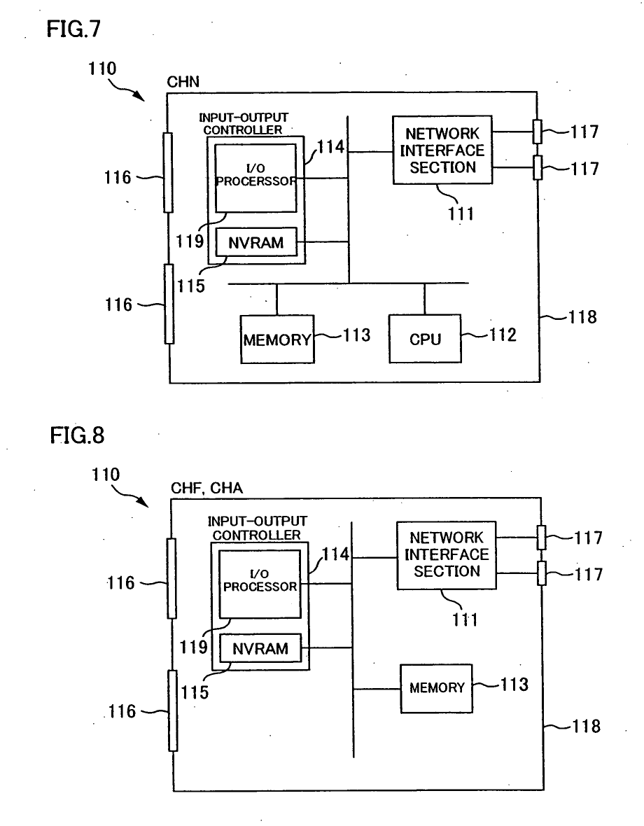

The hardware structure of a CHN 110 is shown in FIG. 7. As shown in FIG. 7, the CHN 110's hardware is constituted as a unit. Hereinafter, this unit is referred to as a NAS board. The NAS board includes one or more circuit boards. More specifically, the NAS board comprises a network interface section 111, a CPU 112, a memory 113, an input-output controller 114, an I/O (Input/Output) processor 119, an NVRAM (Non Volatile RAM) 115, a board connecting connector 116, and a communication connector 117, which are formed as one unit.

The network interface section 111 comprises a communication interface for communicating with the information processing apparatuses 200. In the case of a CHN 110, the communication interface receives file access requests sent from the information processing apparatuses 200 according to, for example, TCP/IP protocols. The communication connector 117 is a connector for communicating with the information processing apparatuses 200. In the case of a CHN 110, the communication connector is a connector that can be connected to the LAN 400 and complies with, for example, Ethernet (registered trademark).

The CPU 112 controls the CHN 110 to function as a NAS board.

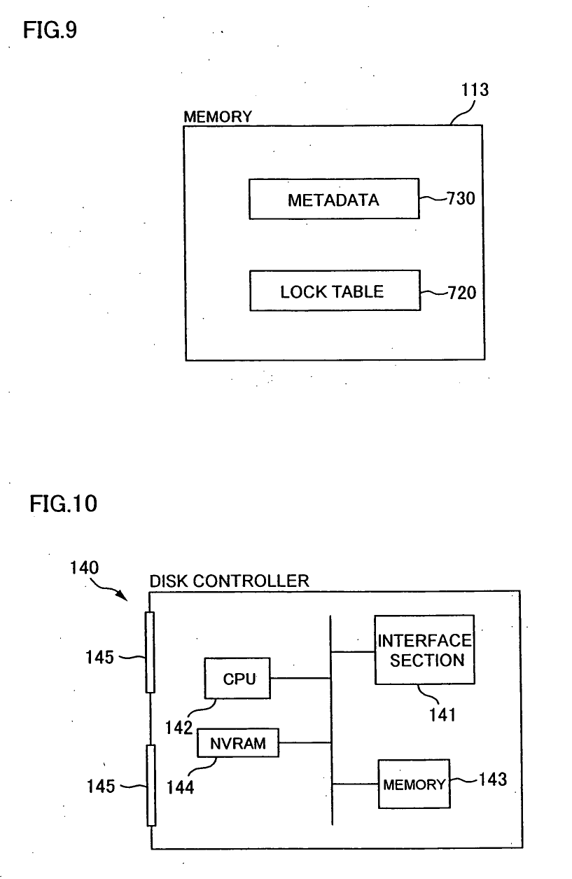

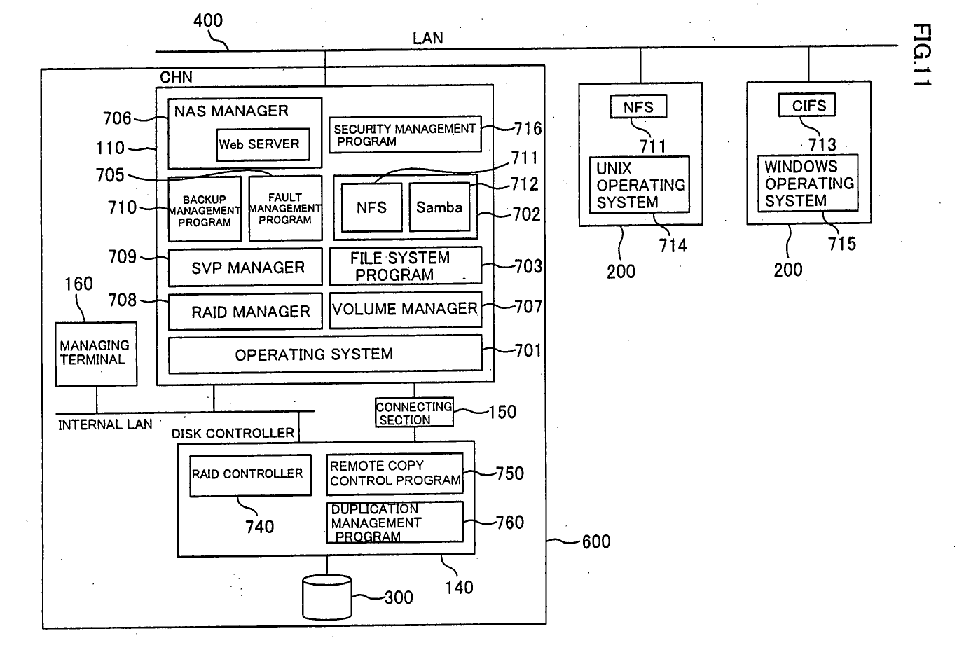

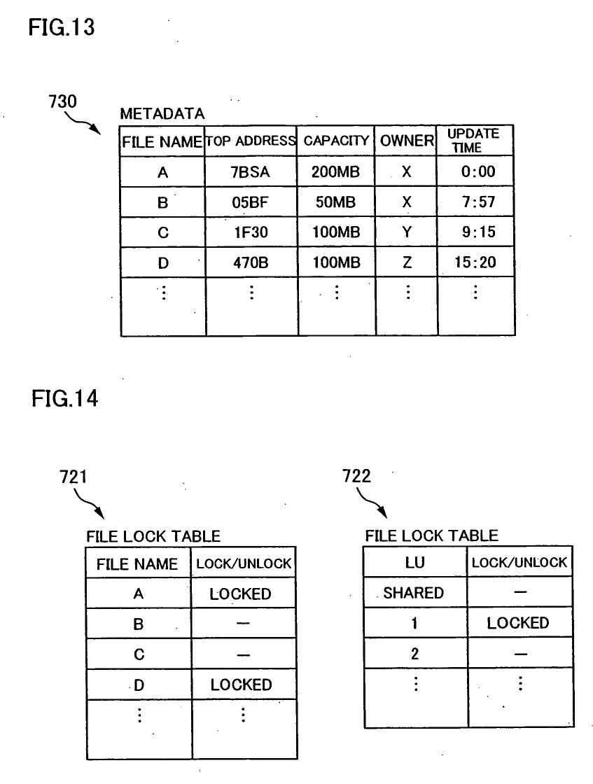

The memory 113 stores various programs and data. For example, metadata 730 and a lock table 720 shown in FIG. 9 and various programs such as a NAS manager 706 shown in FIG. 11 are stored. The metadata 730 is information created for files managed by a file system. The metadata 730 includes information for identifying the storage location of each file such as the address on an LU where the file data is stored and the data size. The metadata 730 may also include the capacity, owner, update time, etc., of each file. Further, the metadata 730 may be created not only for files but also for directories. An example of the metadata 730 is shown in FIG. 13. The metadata 730 is also stored in each LU in the storage device 300.

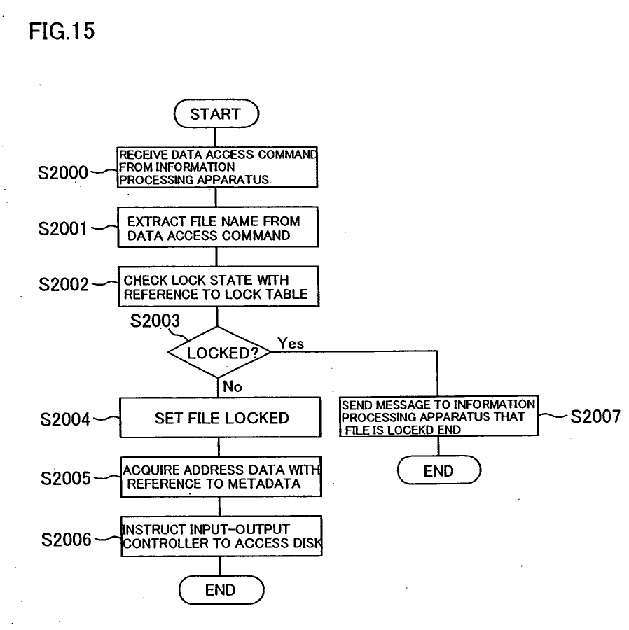

The lock table 720 is a table for performing exclusive control on file accesses from the information processing apparatuses 1 to 3 (200). With exclusive access control, the information processing apparatuses 1 to 3 (200) can share files. The lock table 720 is shown in FIG. 14. As shown in FIG. 14, the lock table 720 includes a file lock table 721 and an LU lock table 722. The file lock table 721 is a table for indicating whether it is locked for each file. When an information processing apparatus 200 has opened a file, the file is locked, to which access from other information processing apparatuses 200 is prohibited. The LU lock table 722 is a table for indicating whether it is locked for each LU. When an information processing apparatus 200 is accessing an LU, the LU is locked, to which access from other information processing apparatuses 200 is prohibited.

Usage of the file lock table 721 and the LU lock table 722 includes the followings. For example, the file lock table 721 can be used for an exclusive control in accesses requested for the same CHN 110 from the information processing apparatus 200, and the LU lock table 722 can be used for an exclusive control in accesses requested for the different CHN 110 from the information processing apparatus 200. This usage is effective in an exclusive control in accesses from the information processing apparatus 200 in the storage system 600 with a plurality of CHNs 110 installed therein as described in the embodiment of the present invention.

In the case that for example the LU is configured so that the CHA 110, CHF 110 and CHN 110 are commonly accessible thereto, the file lock table 721 can be used for an exclusive control in accesses requested for the CHN 110 from the information processing apparatus 200, and the LU lock table 722 can be used for an exclusive control in accesses requested for the commonly accessible LU via the CHA 110, CHF 110 and CHN 110 from the information processing apparatus 200. This usage is effective in an exclusive control in accesses from the information processing apparatus 200 in the storage system 600 with the CHA 110, CHF 110 and CHN 110 installed therein as described in the embodiment of the present invention.

The input-output controller 114 sends and receives data and commands to and from the disk controllers 140, the cache memory 130, the shared memory 120, and the managing terminal 160. The input-output controller 114 comprises the I/O processor 119 and the NVRAM 115. The I/O processor 119 is constituted by, for example, a one-chip micro-computer. The I/O processor 119 controls the sending and receiving of data and commands and relays communication between the CPU 112 and the disk controllers 140. The NVRAM 115 is a nonvolatile memory storing a program to control the I/O processor 119. The contents of a program stored in the NVRAM 115 can be written or rewritten according to instructions from the managing terminal 160 or the NAS manager 706 described later.

Next, the structures of the CHF 110 and the CHA 110 are shown in FIG. 8. The CHF 110 and the CHA 110 are also formed as units in the same way as the CHN 110. Similar to the CHN 110, this unit may be constructed from a plurality of circuit boards. Further, the CHF 110 and the CHA 110 are compatible with the CHN 110 in terms of size and the position and pin arrangement of the board connecting connector 116 and the like.

The CHF 110 and the CHA 110 comprise a network interface section 111, a memory 113, an input-output controller 114, an I/O processor 119, an NVRAM (Non Volatile RAM) 115, a board connecting connector 116, and a communication connector 117.

The network interface section 111 comprises a communication interface for communicating with the information processing apparatuses 200. In the case of a CHF 110, the communication interface receives block access requests sent from the information processing apparatuses 200 according to, for example, the Fibre Channel protocol. In the case of a CHA 110, the communication interface receives block access requests sent from the information processing apparatuses 200 according to, for example, FICON (registered trademark), ESCON (registered trademark), ACONARC (registered trademark), or FIBARC (registered trademark) protocol. The communication connector 117 is a connector for communicating with the information processing apparatuses 200. In the case of a CHF 110, the communication connector 117 is a connector that can be connected to the SAN 500 and complies with, for example, the Fibre Channel. In the case of a CHA 110, the communication connector 117 is a connector that can be connected to the information processing apparatus 5 and complies with, for example, FICON (registered trademark), ESCON (registered trademark), ACONARC (registered trademark), or FIBARC (registered trademark).

The input-output controllers 114 control the whole respective CHFs 110 and CHAS 110 and send and receive data and commands to and from the disk controllers 140, the cache memory 130, the shared memory 120, and the managing terminal 160. By executing various programs stored in the memory 113, the functions of the CHFS 110 and CHAs 110 according to the present embodiment are implemented. The input-output controller 114 comprises the I/O processor 119 and the NVRAM 115. The I/O processor 119 controls the sending and receiving of data and commands. The NVRAM 115 is a nonvolatile memory storing a program to control the I/O processor 119. The contents of a program stored in the NVRAM 115 can be written or rewritten according to instructions from the managing terminal 160 or the NAS manager 706 described later.

Next, the structure of the disk controllers 140 is shown in FIG. 10.

The disk controller 140 comprises an interface section 141, a memory 143, a CPU 142, an NVRAM 144, and a board connecting connector 145, which are formed integrally as a unit.

The interface section 141 comprises a communication interface for communicating with the channel controllers 110, etc., via the connecting section 150, and a communication interface for communicating with the storage device 300.

The CPU 142 controls the entire disk controller 140 and communicates with the channel controllers 110, the storage device 300, and the managing terminal 160. By executing various programs stored in the memory 143 and the NVRAM 144, the functions of the disk controller 140 according to the present embodiment are implemented. The functions implemented by the disk controller 140 are the control of the storage device 300, RAID control, and duplication management, backup control, remote copy control, and the like of data stored in the storage device 300.

The NVRAM 144 is a nonvolatile memory storing a program to control the CPU 142. The contents of a program stored in the NVRAM 144 can be written or rewritten according to instructions from the managing terminal 160 or the NAS manager 706 described later.

The disk controller 140 comprises the board connecting connector 145. By engaging the board connecting connector 145 with the connector on the storage device controlling apparatus 100, the disk controller 140 is connected electrically with the storage device controlling apparatus 100.

Next, the structure of software in the storage system 600 according to present embodiment is shown in FIG. 11.

Running on an operating system 701 is software including a RAID manager 708, a volume manager 707, a SVP manager 709, a file system program 703, a network controller 702, a backup management program 710, a fault management program 705, and an NAS manager 706.

The RAID manager 708 running on the operating system 701 provides functions to set parameters for RAID controllers 740 and to control the RAID controllers 740. The RAID manager 708 accepts parameters and control instructions information from the operating system 701, and other applications and the SVP running on the operating system 701, sets the accepted parameters into a RAID controller 740, and sends the RAID controller 740 control commands corresponding to the control instruction information.

Herein, the set parameters include, for example, parameters for defining storage devices (physical disks) forming a RAID group (specifying RAID group's structure information, stripe size, etc.), a parameter for setting a RAID level (e.g., 0, 1, or 5), and the like. Examples of the control commands which the RAID manager 708 sends to a RAID controller 740 are commands instructing to configure and delete a RAID and to change the capacity thereof, and a command requesting structure information of each RAID group.

The volume manager 707 provides virtualized logical volumes, into which LUs provided by the RAID controller 740 are further virtualized, to the file system program 703. A virtualized logical volume is composed of more than one logical volume.

The main function of the file system program 703 is to manage the correspondence between file names designated in file access requests received by the network controller 702 and addresses on virtualized logical volumes in which the files are stored. For example, the file system program 703 identifies the address on a virtualized logical volume corresponding to a file name designated by a file access request.

The network controller 702 comprises two file system protocols, a NFS (Network File System) 711 and a Samba 712. The NFS 711 accepts a file access request from a UNIX (registered trademark)-based information processing apparatus 200 on which the NFS 711 runs. On the other hand, the Samba 712 accepts a file access request from a Windows (registered trademark)-based information processing apparatus 200 on which a CIFS (Common Interface File System) 713 runs.

The NAS manager 706 is a program for confirming, setting, and controlling the operation state of the storage system 600. The NAS manager 706 has a function as a Web server and provides a setting Web page for the information processing apparatuses 200 to set and control the storage system 600. In response to HTTP (HyperText Transport Protocol) requests from the information processing apparatuses 1 to 3 (200), the NAS manager 706 sends data of the setting Web page to the information processing apparatuses 1 to 3 (200). By use of the setting Web page displayed in the information processing apparatuses 1 to 3 (200), a system administrator, etc., instructs to set and control the storage system 600. Things that can be done by use of the setting Web page are, for example, LU management and setting (capacity management, capacity expansion and reduction, user assignment, etc.); the setting and control (setting of the addresses of the to-be-copied and the to-be-copied-into) concerning functions such as duplication management and remote copy (replication); the setting and control of the backup management program 710 described later; the management of redundantly structured clusters of CHNs, CHFs and CHAs (setting of the correspondence between the channel controllers, whereby, when one fails, another fails over; a fail-over method; etc.); version management of the OS and application programs running on the OS; and the management and setting of the operation state of a security management program 716 and update management (version management) of the security management program 716 providing functions concerning security of data, such as a virus detection program and virus extermination. The NAS manager 706 receives data concerning settings and controls sent from an information processing apparatus 200 due to the operation of the setting Web page and performs the settings and controls corresponding to the data. Thus, various settings and controls of the storage system 600 can be performed from the information processing apparatuses 1 to 3 (200).

The backup management program 710 is a program for backing up data stored in the storage devices 300 via LAN or SAN. The backup management program 710 provides a function of an NDMP (Network Data Management) protocol and communicates, according to the NDMP, with backup software complying with the NDMP operating on an information processing apparatus 200 via the LAN 400. When a backup device 910 is connected to the information processing apparatus 200 via a SCSI, etc., data to be backed up is once read by the information processing apparatus 200 and sent to the backup device 910. When the backup device 910 is connected to the LAN 400, data to be backed up may be transferred to the backup device 910 from the storage system 600 directly without an information processing apparatus 200.

The fault management program 705 is a program for controlling fail-over between the channel controllers 110 which form a cluster.

The SVP manager 709 provides the managing terminal 160 with various services according to requests from the managing terminal 160. For example, the SVP manager 709 provides the managing terminal 160 with the contents of various settings concerning the storage system 600 such as the settings of LUs or RAIDs and makes reflected therein the various settings concerning the storage system 600 entered from the managing terminal 160.

The security management program 716 implements functions of detecting computer viruses, monitoring invasion, update management of a computer virus detection program, extermination of viruses infected a computer, firewall, and the like.

Next, FIG. 12 shows a cluster 180 constituted of two CHNs 110. FIG. 12 shows a case where the cluster 180 is composed of a CHN 1 (channel controller 1) 110 and a CHN 2 (channel controller 2) 110.

As previously mentioned, the fail-over processing is performed between the channel controllers 110 constituting the cluster 180. That is, if any fault occurs in CHN 1 (110) and it becomes impossible to continue a processing, the CHN 2 (110) takes over the processing that has been performed by the CHN 1 (110). The fault management program 705 executed by the CHN 1 (110), and the CHN 2 (110) implements the fail-over processing.

Both CHN 1 (110) and CHN 2 (110) execute the fault management program 705, write in the shared memory 120 to indicate that the processing thereof is normally performed, and confirm each other whether the other has written. When one cannot detect the writing by the other, the one determines that a fault has occurred in the other and performs fail-over processing. In the fail-over processing, the processing that has been performed by the other is taken over via a shared LU 310.

Accordingly, the shared LU is used for storing information of large data amount such as the information used for processing by the CPU 112 of the CHN 110. This is because the shared LU 310 has a large storage capacity and the capacity is capable of scalable expansion. On the other hand, the shared memory 120 is used for storing for example configuration information collected by the input-output controller 114 of the CHA 110, CHF 110 and CHN 110 since its memory capacity is smaller than that of the region of the shared LU 310.

Further, the file access processing section of each of CHNs 110 forming the cluster 180 can manage the accessible information processing apparatus 1 to 3 (200). Accordingly, it can be achieved that only when a file access request is sent from the accessible information processing apparatus 1 to 3 (200), the CHN accepts the file access request. The accessible information processing apparatus 1 to 3 (200) is managed by recording the domain name (identification information) of the IP address of the information processing apparatus 1 to 3 (200), which is allowed to access, in each CHN 110's memory 113 beforehand.

Thus, even when the information processing apparatuses 1 to 3 (200) are connected to the storage system 600 via a common LAN 400, LUs can be assigned exclusively to the information processing apparatuses 1 to 3 (200), respectively. For example, when the information processing apparatuses 1 to 3 (200) are computers of respective different enterprises, storage service in which data confidentiality is maintained from the others can be provided to each of the information processing apparatuses 1 to 3 (200).

The abovementioned settings of each CHN 110 can be performed from the managing terminal 160 and the information processing apparatuses 1 to 3 (200). When the information processing apparatuses 1 to 3 (200) perform the settings, the information processing apparatuses 1 to 3 (200) use the setting Web page displayed in the information processing apparatuses 1 to 3 (200) by the NAS manager 706 running on the CHN 110 to do so.

===Exclusive Control of File Data===

Next, a description will be given of exclusive control of file data according to the present embodiment. As previously mentioned, the exclusive control includes exclusive control in terms of files and exclusive control in terms of LUs. With these exclusive controls, a file can be updated in a proper order, and thus the file can be shared between the information processing apparatus 1 to 3 (200). The exclusive control according to the present embodiment is implemented by a network file system program executed by the CPU 112 or the I/O processor 119, which are provided in a CHN 110. The network file system program is composed of codes to perform various operations. Herein, the network file system program is a program to control the file system protocol such as the NFS 711 and the Samba 712.

First, a flow chart is shown in FIG. 15 for explaining the exclusive control in files according to the present embodiment.

The network interface section 111 of the CHN 110 receives a file access request (data access command) from any one of the information processing apparatuses 1 to 3 (200) (S2000). The file access request contains a file name, a file access type such as read or write, data to be written in the case of writing, header information of the communication protocol of the LAN 400, and the like. The CPU 112 then extracts the file name from the file access request received by the network interface section 111 (S2001). The CPU 112 refers to the file lock table 721 stored in the memory 113 and checks a lock state of the file based on the file name extracted from the file access request (S2002).

If the file is locked (S2003), the file is not allowed to be accessed because another information processing apparatus 200 is accessing the file. Therefore, the CPU 112 sends a message that the access is prohibited to the information processing apparatus 200 which has sent the file access request (S2007). Note that, when the file to which the access has been requested is locked, the access to the file is not always prohibited without exception, that is, it is possible to prohibit the access in accordance with the type of access, for example, only in the case of writing. Moreover, it is possible that the CHN 110 not only sends the message that the access to the file is prohibited to the information processing apparatus 200, but also, when the lock of the file is released thereafter, the CHN 110 may send a message to the information processing apparatus 200 that the lock is released. The information processing apparatus 200 having received the message that the access to the file is prohibited may discontinue the access to the file or access the file again after a predetermined period of time. Furthermore, the information processing apparatus 200 can access the file again after receiving the message from the CHN 110 that the lock is released.

If the file to which the access is requested by the information processing apparatus 200 is not locked (S2003), the CPU 112 sets the file in the file lock table 721 to be locked (S2004). Thus, other information processing apparatuses 200 are prohibited from accessing the file. The CPU 112 then refers to the metadata 730 stored in the memory 113 and acquires a top storage location and data length (capacity) of data of the file (S2005). Subsequently, the CPU 112 instructs disk access to the input-output controller 114 (S2006). The input-output controller 114 generates an I/O request corresponding to the file access request based on the storage location and the data length of the file and outputs the generated I/O request to the relevant disk controller 140. The data access, namely, read and write of data is thus performed. After the data access is completed, the lock of the file is released.

As a result of checking the file lock table 721 in S2002, if the file to which the access is requested by the information processing apparatus 200 is not registered in the file lock table 721, the file is added to the file lock table 721 and the steps after S2004 are performed.

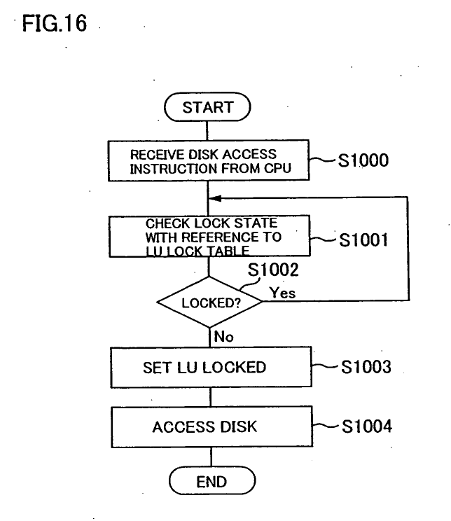

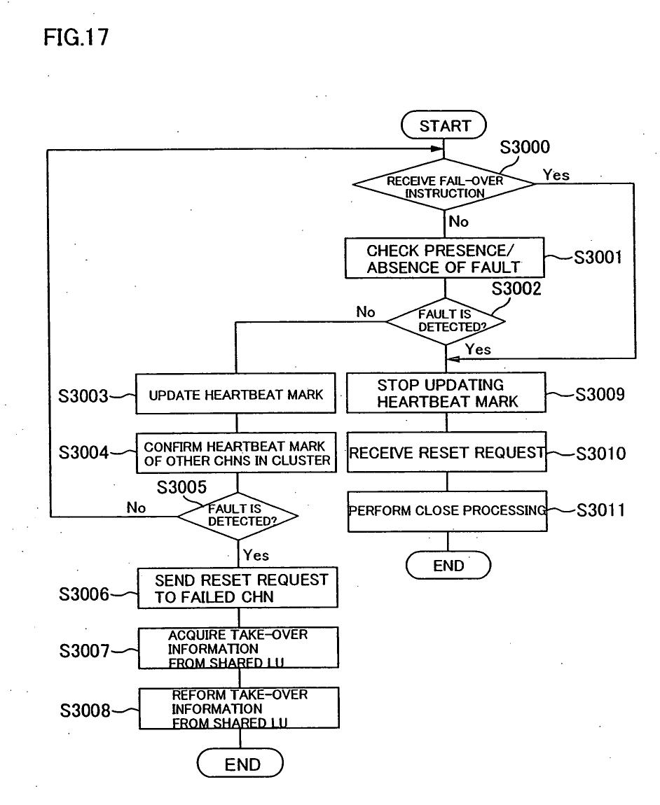

The I/O processor 119 of the input-output controller 114 outputs the I/O request to the disk controller 140 in accordance with the disk access instruction received from the CPU 112. Herein, the exclusive control in LUs is performed. A flowchart illustrating the exclusive control in LUs shown in FIG. 16.

First, the I/O processor 119 accepts the disk access instruction from the CPU 112 (S1000). Second, the I/O processor 119 refers to the LU lock table 722 stored in the memory 113 and checks the lock state of the LU 310 which is to be accessed (S1001). If the LU is locked, the I/O processor 119 waits until the lock is released (S1002). When the lock is released, the I/O processor 119 sets the LU in the LU lock table 722 to be locked (S1003). Thus, the other accesses to the LU are prohibited. The I/O processor 119 then generates an I/O request and outputs the generated I/O request to the relevant disk controller 140 (S1004). The I/O request contains a top address of data, a data length, an access type such as read or write, data to be written in the case of writing, and the like. When the data access is completed, the lock of the LU is released.

Moreover, since the exclusive control of files is performed by use of the file lock table 721 or the LU lock table 722, even when file access requests sent from the information processing apparatuses 1 to 3 (200) follow different network file system protocols, the effect of the exclusive control can be reflected on the file access requests according to the respective network file system protocols.

The above-described exclusive control is performed in the CHNs 110. The storage device controlling apparatus 100 in the storage system 600 according to the present embodiment can include the CHNs 110, the CHFs 110, and the CHAs 110 together and attach these thereon. In such a construction, the information processing apparatuses 1 to 3 (200) connected to the storage system 600 according to the present embodiment can implement sharing of file data therebetween.

===Fail-Over Control===

Next, a description will be given of the fail-over control according to the present embodiment. The fail-over control is implemented by the fault management program 705 executed by the CPU 112 and the I/O processor 119, which are provided in a CHN 110. The fault management program 705 is composed of a code to perform various operations.

As shown in FIG. 12, the fail-over control is performed between the CHNs 110 forming the cluster 180. The cluster 180 can be set by the NAS manager 706. The fail-over control is performed when a fault occurs in one of the CHNs 110, and also performed by an instruction (request to execute fail-over) from the NAS manager 706.

FIG. 17 shows a flowchart for explaining the fail-over control according to the present embodiment.

The CPU 112 starts the fail-over processing on receiving the fail-over instruction (execution request) from the NAS manager 706 (S3000).

Whether the NAS manager 706 has made the fail-over instruction can be checked within a processing routine of the fault management program 705 as shown in FIG. 17. Alternatively, an interruption signal may be generated when the NAS manager 706 makes the fail-over instruction.

In the case where there is no fail-over instruction by the NAS manager 706, the CPU 112 checks whether a fault has occurred in the CHN 110 of its own (S3001).

When no fault is detected (S3002), the CPU 112 updates a heartbeat mark in the shared memory 120 (S3003). The heartbeat mark is information for the CHNs 110 in the cluster 180 to confirm the operation states of each other. Specifically, each CHN 110 periodically writes the heartbeat mark into a predetermined area in the shared memory 120 to indicate to the other CHN 110 that the processing thereof is normally performed. Moreover, each CHN 110 confirms the heartbeat marks of the other CHN 110. The CHNs 110 in the cluster 180 can thus monitor a fault with each other.

The heartbeat mark contains information such as an identifier of the CHN 110, a code indicating whether the CHN 110 is operated normally or abnormally, and an update time. The CPU 112 subsequently reads the heartbeat marks of the other CHN 110 in the cluster 180 from the shared memory 120 and confirms whether the read heartbeat marks are normally updated (S3004). When all the heartbeat marks of the CHNs 110 in the cluster are normally updated, it is judged that no fault has occurred (S3005), and the steps from S3000 are repeated.

If, as a result of confirming the heartbeat marks of the other CHN 110 in S3004, the CPU 112 finds a heartbeat mark which is not updated even after a predetermined period of time or a heartbeat mark with the code indicating fault occurrence, the CPU 112 starts the fail-over processing. First, the CPU 112 causes the I/O processor 119 to send a reset request to the failed CHN 110 (S3006). If the CPU 112 receives a message from the failed CHN 110 that the reset request has been received, the CPU 112 acquires from the shared LU 310 information to be taken over concerning the failed CHN 110 (S3007).

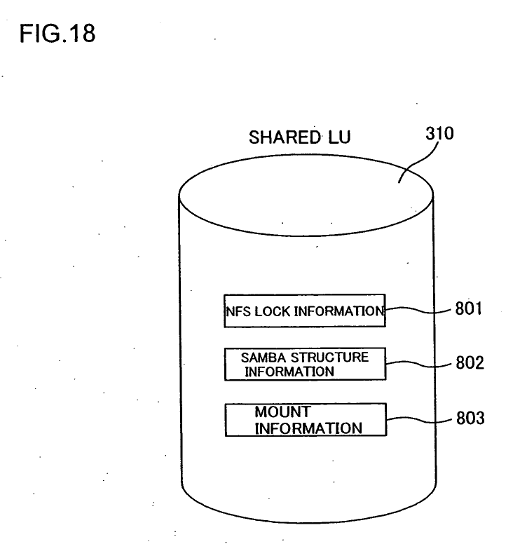

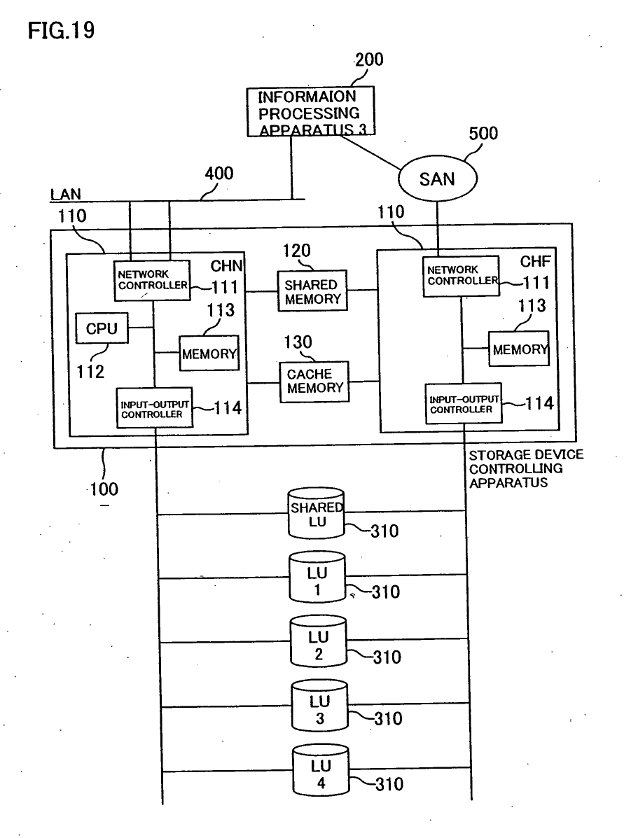

As shown in FIG. 18, the information to be taken over, which is stored in the shared LU 310, includes lock information 801, structure information 802 of the Samba 712, and mount information 803. The lock information 801 includes the file lock table 721 and the LU lock table 722 which have been managed by the failed CHN 110. The mount information 803 is information concerning the mount of file systems constructed in the LUs which have been managed by the failed CHN 110. Besides the above information, the information to be taken over includes an MAC (Media Access Control) address or an IP (Internet Protocol) address of the network interface section 111, export information of the network file system, and the like, which are acquired from the shared memory 120.

The CPU 112 which has acquired the above information performs take-over processing (S3008). First, CPU 112 sets the MAC address or IP address of the failed CHN 110 into the network interface section 111 of its own. This enables the CHN 110 which has taken over the processing to response to accesses to the failed CHN 110 from the information processing apparatuses 1 to 3 (200). Moreover, based on the mount information of the failed CHN 110, the file system of the failed CHN 110 is mounted on the file system of the CHN 110 which has taken over the processing. This enables the CHN 110 which has taken over the processing to access the LU 310 which has been managed by the failed CHN 110. At this time, it is checked whether the metadata which has been managed in the failed CHN 110 includes a failure. This is because a failure sometimes occurs during update of the metadata. The check is performed by executing a metadata check program by the CPU 112 of the CHN 110 which has taken over the metadata. When a failure is detected in the metadata as a result of the check, the metadata is restored, for example, by correcting management information of an i-node in the case of the UNIX (registered trademark)-based operating system. Moreover, based on the export information of the network file system, the CPU 112 disclose the file system to the information processing apparatuses 1 to 3 (200) connected to the LAN 400. Furthermore, the CPU 112 takes over and executes the processing (processing in the channel controller) which the failed CHN 110 was executing. The take-over processing is thus completed.

Meanwhile, if the CPU 112 finds a fault as a result of checking whether a fault has occurred in the CHN 110 of its own in S3001, or if the CPU 112 receives the fail-over instruction from the NAS manager 706 in S3000, the CPU 112 stops updating the heartbeat mark in the shared memory 120 (S3009). Note that the occurrence of a fault is detected not only by the check performed in S3001, but also by a hardware interruption. Also in such a case, the CPU 112 stops updating the heartbeat mark in the shared memory 120. Consequently, another CHN 110 in the cluster 180 detects that the update of the heartbeat mark has been stopped, and then the fail-over processing is started.

The reset request is sent to the CHN 110 which has stopped updating the heartbeat mark from the I/O processor 119 of the CHN 110 which takes over the processing (S3010). This reset request is sent in S3006 of the processing routine of the fault management program 705 executed in the CHN 110 which takes over the processing. The CHN 110 which has stopped updating the heartbeat mark then return a message that the reset signal has been accepted, and starts a close processing (S3011).

The close processing is performed by obtaining a dump of the memory 113. To obtain the dump of the memory 113 is to record data stored in the memory 113 into the LU 310.

Note that the cluster may be constituted of three or more CHNs 110. In this case, multistage fail-over processing can be performed. Specifically, when a fault occurs in the CHN 110 which has taken over the processing due to fail-over, still another CHN 110 can take over the processing. In this case, the CHN 110 which finally takes over the processing takes over all the processing that has been taken over in the past fail-over processing.

The abovementioned fail-over control is performed in the CHNs 110 within the cluster 180. In the storage system 600 according to the embodiment, the CHNs 110, the CHFs 110, and the CHAs 110 can be included together and attached to the slots of the storage device controlling apparatus 100. In such a construction, the cluster 180 can be formed. Within the cluster 180, even when a fault occurs in one CHN 110, another CHN 110 can take over the processing thereof.

===Fast Access to File===

Next, a description will be given of control of fast access to files according to the present embodiment. The control of fast access to files according to the present embodiment is control to perform fast data access in blocks via the SAN 500 from the information processing apparatuses 200 to file data stored in a storage device 300. The information processing apparatus 200 performing the fast access to files needs to be connected to the CHN 110 and the CHF 110 so as to be able to communicate with the both, which is the information processing apparatus 3 (200) in FIG. 1. FIG. 19 shows a block diagram for explaining the control of fast access to files.

The information processing apparatus 3 (200) is connected to the CHN 110 via the LAN 400 as well as to the CHF 110 via the SAN 500. This enables the information processing apparatus 3 (200) to access file data stored in the LU 310 via the CHN 110 and to access the same data via the CHF 110. In the case of access via the CHN 110, the information processing apparatus 3 (200) accesses data in files, while the information processing apparatus 3 (200) accesses data in blocks in the case of access via the CHF 110.

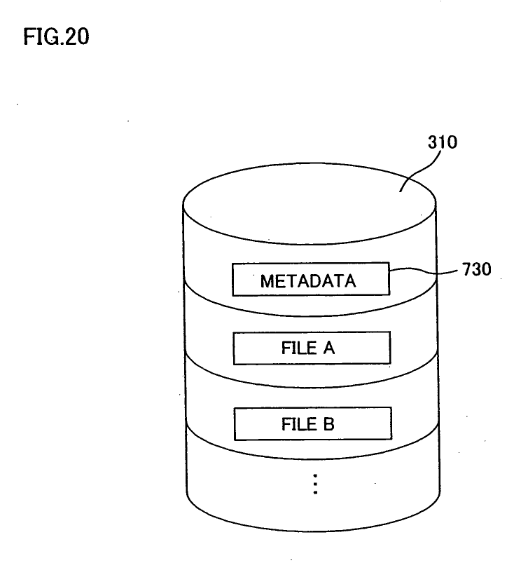

Normally, in the case of accessing data stored in the LU 310 via the CHN 110, the information processing apparatus 3 (200) makes a file access request to the CHN by specifying a file name. However, in the case of accessing data stored in the LU 310 by means of the control of fast access to files according to the present embodiment, the information processing apparatus 3 (200) makes a request (request) for the metadata 730 (information specifying a storage location of the file on the memory area of the storage unit) to the CHN 110 by specifying the file name. After accepting the request for the metadata 730, the CHN 110 reads the metadata 730 corresponding to the file name stored in the memory 113 or the cache memory 130, and then sends the read metadata 730 to the information processing apparatus 3 (200) via the LAN 400. Since the metadata 730 is also stored in the LU 310 as shown in FIG. 20, the CHN 110 can read the metadata 730 from the LU 310. Moreover, it is possible that, when receiving the request for the metadata 730 from the information processing apparatus 3 (200), the CHN 110 confirms the lock state of the file data in the file lock table 721, thereby performing the exclusive control with respect to the file data.

By acquiring the metadata 730, the information processing apparatus 3 (200) can obtain the storage location and the data size of the file. The information processing apparatus 3 (200) can generate a block access request for the file data based on the above information and then sends the block access request to the CHF 110 via the SAN 500.

The CHF 110 accepts the block access request by the network interface section 111. The I/O processor 119 thereof then extracts the storage location of the data, the data length, and the like, and generates an I/O request corresponding to the block access request to output the I/O request to the relevant disk controller 140. The data is thus read or written.

Since the SAN 500 is a network which enables faster data transfer than the LAN 400, the file data stored in the storage device 300 can be accessed at higher speed.

In the case of reading the file data from the storage device 300, the information processing apparatus 3 (200) sends a request to read data in blocks to the CHF 110 by specifying the address and the size of the file data. The CHF 110 sends data read from the storage device 300 to the information processing apparatus 3 (200) via the SAN 500. After acquiring the data from the CHF 110, the information processing apparatus 3 (200) ends the read processing. If the file is locked when the information processing apparatus 3 (200) acquires the metadata 730 from the CHN 110, the information processing apparatus 3 (200) sends a request to the CHN 110 to release the lock.

Meanwhile, in the case of writing file data into the storage device 300, the information processing apparatus 3 (200) sends data to be written and a request to write data in blocks by specifying the address and the size of the data to be written. The CHF 110 writes the data to be written into the storage device 300 and sends a message to inform the end of writing to the information processing apparatus 3 (200). After receiving the message of end of writing from the CHF 110, the information processing apparatus 3 (200) requests the CHN 110 to update the metadata 730. If the file is locked when the information processing apparatus 3 (200) acquires the metadata 730 from the CHN 110, the information processing apparatus 3 (200) sends a request to the CHN 110 to release the lock.

The control of fast access to files according to the present embodiment is highly effective when accessing a file of a large data size. By accessing the file of a large data size via the SAN 500, which allows high-speed transfer, time for reading or writing file data can be reduced. This can be implemented because, in the storage system 600 according to the present embodiment, the CHNs 110, the CHFs 110, and the CHAs 110 can be included together and attached in the slots of the storage device controlling apparatus 100, and features of both data accesses via the CHN 110 and via the CHF 110 can be properly utilized.

According to the present invention, it is possible to provide a storage device controlling apparatus and a method of controlling the storage device controlling apparatus.

Although the preferred embodiment of the present invention has been described in detail, it should be understood that various changes, substitutions and alterations can be made therein without departing from spirit and scope of the inventions as defined by the appended claims.

1. A storage device controlling apparatus including a channel controller having a circuit board on which a file access processing section and an I/O processor are formed, the file access processing section receiving requests to input and output data in files as units sent from at least one information processing apparatus via a network, the I/O processor outputting I/O requests corresponding to said requests to input and output data to a storage device, said apparatus comprising:
an exclusive control section performing exclusive control of a file when said channel controller receives from said information processing apparatus said requests to input and output data of the file.

2. A storage device controlling apparatus according to claim 1, wherein said requests to input and output data are sent in accordance with at least two types of network file system protocols, and if, during said exclusive control which is performed upon accepting one of said requests to input and output data sent in accordance with one of network file system protocols, another said request to input/output data sent in accordance with another network file system protocol is accepted, an effect of said exclusive control is also reflected on the another request to input/output data.

3. A storage device controlling apparatus according to claim 1,
wherein a memory area of said storage device is managed in a logical volume serving as a unit, the logical volume being logically set on the memory area, and
said I/O processor performs exclusive control of said logical volume in response to said exclusive control of the file.

4. A storage device controlling apparatus including a channel controller having a circuit board on which a file access processing section and an I/O processor are formed, the file access processing section receiving requests to input and output data in files as units sent from an information processing apparatus via a network, the I/O processor outputting I/O requests corresponding to said requests to input and output data to a storage device, said apparatus comprising:
a section receiving from said information processing apparatus a request for information specifying a storage location of a file on a memory area of said storage device, and sending said information to said information processing apparatus;
a section receiving a request to read data in blocks as units from said information processing apparatus, in which the request is generated based on said information, and outputting an I/O request corresponding to the request to read data to said storage device; and
a section sending data read from said storage device to said information processing apparatus.

5. A storage device controlling apparatus according to claim 4, wherein a plurality of the channel controllers are provided therein, and the channel controllers include at least one enabled to communicate with the information processing apparatus through a LAN and at least one enabled to communicate with the information processing apparatus through a Fibre Channel.

6. A storage device controlling apparatus including a channel controller having a circuit board on which a file access processing section and an I/O processor are formed, the file access processing section receiving requests to input and output data in files as units sent from an information processing apparatus via a network, the I/O processor outputting I/O requests corresponding to said requests to input and output data to a storage device, said apparatus comprising:
a section receiving from said information processing apparatus a request for information specifying a storage location of a file on a memory area of said storage device, and sending said information to said information processing apparatus; and
a section receiving a request to write data in blocks as units and data to be written from said information processing apparatus, in which the request is generated based on said information, and outputting to said storage device an I/O request corresponding to the request to write data and the data to be written.

7. A storage device controlling apparatus according to claim 6, wherein a plurality of the channel controllers are provided therein, and the channel controllers include at least one enabled to communicate with the information processing apparatus through a LAN and at least one enabled to communicate with the information processing apparatus through a Fibre Channel.

8. A storage device controlling apparatus including a plurality of channel controllers, each having a circuit board on which a file access processing section and an I/O processor are formed, the file access processing section receiving requests to input and output data in files as units sent from an information processing apparatus via a network, the I/O processor outputting I/O requests corresponding to said requests to input and output data to a storage device, said apparatus comprising:
a section setting at least one of logical volumes logically set on a memory area of said storage device as a shared logical volume accessible from each of said channel controllers; and
a section performing fail-over based on take-over information of each of said channel controllers, in which the take-over information is stored in said shared logical volume and used when one of said channel controllers takes over processing of another one of said channel controllers.

9. A storage device controlling apparatus according to claim 8, wherein said fail-over is performed in any one of cases where a request to perform said fail-over is received from said information processing apparatus and where a fault occurs in said another channel controller.

10. A storage device controlling apparatus including a channel controller having a circuit board on which a file access processing section and an I/O processor are formed, the file access processing section receiving requests to input and output data in files as units sent from at least one information processing apparatus via a network, the I/O processor outputting I/O requests corresponding to said requests to input and output data to a storage device,
wherein said file access processing section stores identification information of accessible said information processing apparatus, and accepts said requests to input and output data only in a case where said requests to input and output data are sent from said information processing apparatus for which said identification information is stored.

11. A method of controlling a storage device controlling apparatus including a channel controller having a circuit board on which a file access processing section and an I/O processor are formed, the file access processing section receiving requests to input and output data in files as units sent from at least one information processing apparatus via a network, the I/O processor outputting I/O requests corresponding to said requests to input and output data to a storage device, said method comprising the steps of:
receiving said requests to input and output data of a file from said information processing apparatus by said channel controller; and
performing exclusive control of said file.

12. A method of controlling the storage device controlling apparatus according to claim 11, wherein said requests to input and output data are sent in accordance with at least two types of network file system protocols, and if, during said exclusive control which is performed upon accepting one of said requests to input and output data sent in accordance with one of the network file system protocols, another said request to input/output data sent in accordance with another network file system protocol is accepted, an effect of said exclusive control is also reflected on the another request to input/output data.

13. A method of controlling the storage device controlling apparatus according to claim 11,
wherein a memory area of said storage device is managed in a logical volume serving as a unit, the logical volume logically being set on the memory area, and
said I/O processor performs exclusive control of said logical volume in response to said exclusive control of the file.

14. A method of controlling a storage device controlling apparatus including:
a channel controller having a circuit board on which a file access processing section and an I/O processor are formed, the file access processing section receiving requests to input and output data in files as units sent from an information processing apparatus via a network, the I/O processor outputting I/O requests corresponding to said requests to input and output data to a storage device; and
a section receiving a request to read data in blocks as units sent from said information processing apparatus, and outputting an I/O request corresponding to the request to read data to said storage device, said method comprising the steps of:
receiving a request for information specifying a storage location of a file on a memory area of said storage device from said information processing apparatus, and sending said information to said information processing apparatus;
receiving said request to read data in blocks as units from said information processing apparatus, in which the request is generated based on said information;
outputting said I/O request corresponding to said request to read data to said storage device; and
sending data read from said storage device to said information processing apparatus.

15. A storage device controlling apparatus according to claim 14, wherein a plurality of the channel controllers are provided therein, and the channel controllers include at least one enabled to communicate with the information processing apparatus through a LAN and at least one enabled to communicate with the information processing apparatus through a Fibre Channel.

16. A method of controlling a storage device controlling apparatus including:
a channel controller having a circuit board on which a file access processing section and an I/O processor are formed, the file access processing section receiving requests to input and output data sent in files as units from an information processing apparatus via a network, the I/O processor outputting I/O requests corresponding to said requests to input and output data to a storage device; and
a section receiving a request to write data in blocks as units sent from said information processing apparatus, and outputting an I/O request corresponding to the request to write data to said storage device, said method comprising the steps of:
receiving a request for information specifying a storage location of a file on a memory area of said storage device from said information processing apparatus, and sending said information to said information processing apparatus;
receiving said request to write data in blocks as units and data to be written from said information processing apparatus, in which the request is generated based on said information; and
outputting said I/O request corresponding to said request to write data and said data to be written to said storage device.

17. A storage device controlling apparatus according to claim 16, wherein a plurality of the channel controllers are provided therein, and the channel controllers include at least one enabled to communicate with the information processing apparatus through a LAN and at least one enabled to communicate with the information processing apparatus through a Fibre Channel.

18. A method of controlling a storage device controlling apparatus including a plurality of channel controllers, each having a circuit board on which a file access processing section and an I/O processor are formed, the file access processing section receiving requests to input and output data in files as units sent from an information processing apparatus via a network, the I/O processor outputting I/O requests corresponding to said data to input and output data to a storage device, said method comprising the steps of:
setting at least one of logical volumes logically set on a memory area of said storage device as a shared logical volume accessible from each of said channel controllers; and
performing fail-over based on take-over information of each of said channel controllers, in which the take-over information is stored in said shared logical volume and used when one of said channel controllers takes over processing of another one of said channel controllers.

19. A method of controlling the storage device controlling apparatus according to claim 18, wherein said fail-over is performed in any one of cases where a request to perform said fail-over is received from said information processing apparatus and where a fault occurs in said another channel controller.

20. A method of controlling a storage device controlling apparatus including a channel controller having a circuit board on which a file access processing section and an I/O processor are formed, the file access processing section receiving requests to input and output data in files as units sent from at least one information processing apparatus via a network, the I/O processor outputting I/O requests corresponding to said requests to input and output data to a storage device, said method comprising the steps of:
storing identification information of accessible said information processing apparatus by said file access processing section; and
accepting said requests to input and output data only in a case where said requests to input and output data are sent from said information processing apparatus for which said identification information is stored.
